(19) United States
(12) Patent Application Publication
(10) Pub. No.: US 2022/0237057 A1
(43) Pub. Date: Jul. 28, 2022

(54) CODE CONSOLIDATION SYSTEM

(71) Applicant: Bank of America Corporation, Charlotte, NC (US)

(72) Inventors: Michael Emil Ogrinz, Easton, CT (US); Siddhesh V. Wadikar, Denver, CO (US); Allison D. Baker, Charlotte, NC (US); Gerard P. Gay, Charlotte, NC (US); Jeremiah W. Fellows, Centennial, CO (US); Susan E. Teague Rector, Denver, CO (US); Regina Peyfuss, Denver, CO (US); Mark A. Odiorne, Waxhaw, NC (US)

(21) Appl. No.: 17/158,921

(22) Filed: Jan. 26, 2021

(51) Int. Cl. G06F 9/54; G06F 8/36; G06F 11/30

(52) U.S. Cl. CPC G06F 9/547; G06F 11/3086; G06F 8/36

(57) ABSTRACT

A code identifies a first segment of code included in a first computer program stored on a first repository that matches, within a threshold range, a second segment of code included in a second computer program stored on a second repository. The first segment of code and the second segment of code perform one or more computing tasks. An application programming interface (API) is generated that performs the one or more computing tasks of the first and second segments of code. The first segment of code within the first computer program is replaced with a first call to the generated API. The second segment of code within the second computer program is replaced with a second call to the generated API.

### TECHNICAL FIELD

The present disclosure relates generally to software programming, more specifically to a code consolidation system.

### BACKGROUND

Programming code includes instructions for performing computing. Programming code may be presented in a human-readable programming language. Specialized training and knowledge of a code's programming language is generally required to understand the function(s) of a given piece of code and to create new code to perform a desired task. Portions of code are combined to prepare computer applications or programs. An application programming interface (API) is a software intermediary for communicating between difference applications or programs.

### SUMMARY

This disclosure recognizes that previous technology for managing programming code has several disadvantages and inefficiencies. For example, previous technology may waste computing resources (e.g., memory and processing resources, network bandwidth, and the like) by executing the same or similar code repeatedly on different machines. As another example, if code is improved for one application or program, previous technology generally fails to implement these improvements universally, such that any performance gains are not fully realized in all systems employing the same or similar code. Because of this failure, many implementations may use older versions of code, such that any benefits of the new code are not obtained. Continued use of outdated code may result in the propagation of security and/or performance flaws of the older code, and previous technology generally fails to provide a reliable means for preventing such scenarios.

Certain embodiments of this disclosure solve technical problems of previous technology used for managing programming code by providing a code consolidation system that is configured to facilitate the automatic consolidation of code segments that appear in multiple programs. The disclosed system automatically transforms instances of code that are repeated in multiple applications into calls to APIs that are generated to perform the same tasks. The disclosed system provides several technical advantages over previous technology, which include: (1) improved efficiency of code implementation by the automatic transformation of code that is determined to appear in multiple programs with calls to APIs configured to perform the same computing task(s); (2) improved implementation of changes to code, such that the most up-to-date code is automatically propagated to all programs with little or no cost in terms of utilization of network bandwidth and/or other computing resources; and (3) improved reporting and record keeping of changes to code. As such, this disclosure may improve the function of computer systems used to manage programming code. The code consolidation system described in this disclosure may help ensure the most up-to-date and/or administrator approved code is implemented in all devices. This disclosure may particularly be integrated into a practical application of a code consolidation system which automatically scans the underlying code of multiple applications or programs, detects repeated code segments, generates one or more APIs for performing the function(s) of these code segments, and replaces the code segments with calls to the appropriate API(s).

Certain embodiments of this disclosure may include some, all, or none of these advantages. These advantages and other features will be more clearly understood from the following detailed description taken in conjunction with the accompanying drawings and claims.

In one embodiment, a system includes a first repository storing a first set of computer programs and a second repository storing a second set of computer programs. A code consolidation device is communicatively coupled to the first repository and the second repository. The code consolidation identifies a first segment of code included in a first computer program stored on the first repository that matches, within a threshold range, a second segment of code included in a second computer program stored on the second repository. The first segment of code and the second segment of code are configured to perform one or more computing tasks. An application programming interface (API) is generated that is operable to perform the one or more computing tasks of the first and second segments of code. The generated API is stored. The first segment of code within the first computer program is replaced with a first call to the generated API. The second segment of code within the second computer program is replaced with a second call to the generated API.

### BRIEF DESCRIPTION OF THE DRAWINGS

For a more complete understanding of this disclosure, reference is now made to the following brief description, taken in connection with the accompanying drawings and detailed description, wherein like reference numerals represent like parts.

FIG. 1 is a schematic diagram of an example system configured for code consolidation;

FIG. 2 is a flow diagram illustrating an example of the replacement of a code segment with an API call;

FIG. 3 is a flowchart of a method for operating the system of FIG. 1; and

FIG. 4 is a diagram of an example device configured to implement various components of the system of FIG. 1.

### DETAILED DESCRIPTION

As described above, previous technology typically fails to facilitate efficient and reliable management of programming code. The code consolidation system described in this disclosure provides a technical solution to these problems of previous technology by automatically replacing code segments that appear in multiple programs with calls to APIs that provide the same functionality. The code consolidation system of this disclosure may provide improved code optimization, such that code can be tested and/or updated more efficiently and any performance improvements are guaranteed to be propagated to all associated devices and programs. As an example, using previous technology, if a given program is scanned to detect bugs and/or other flaws, issues with a segment of code are only detected in that single program. Thus, other programs containing the same flawed segment of code are not detected and appropriate corrective actions are not taken. The code consolidation system of this disclosure solves this and related technical problems by replacing repeated code segments with corresponding API calls. The centralized code associated with a given API can be scanned for bugs and/or other flaws, and any corrective changes to the API are automatically propagated to all programs calling the API, resulting in improved system performance. The code consolidation system of this disclosure may also or alternatively provide increased visibility to which applications or programs are being executed most often. This information may facilitate for example the reconfiguration of hardware resources for programs that are used more frequently. Programs that are never used may be retired or resources for such programs may be decreased.

### Code Consolidation System

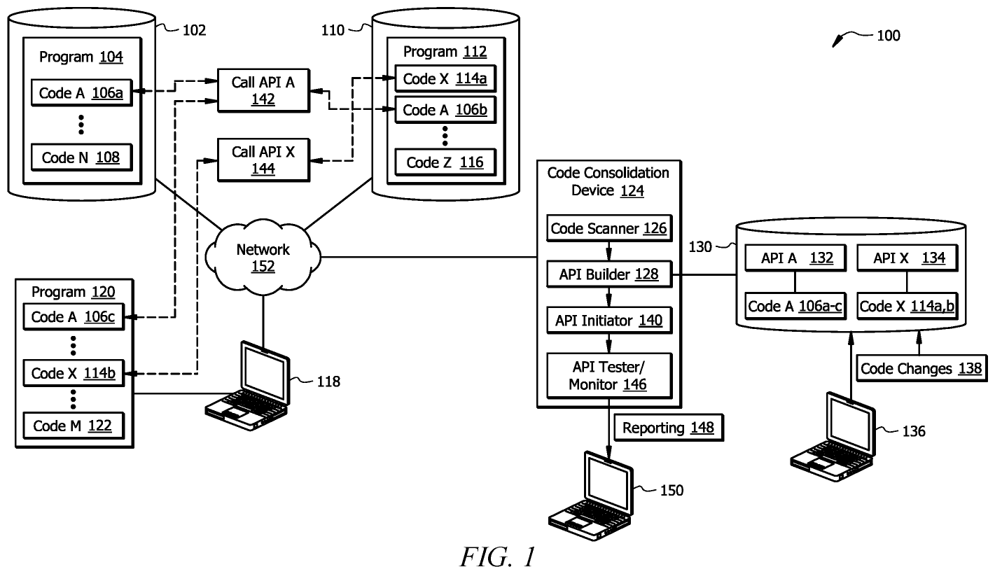

FIG. 1 is a schematic diagram of an example code consolidation system 100. The system 100 includes program repositories 102, 110, a computing device 118, a code consolidation device 124, an API database 130, a programmer device 136, an administrator device 150, and a network 152. The code consolidation device 124 is generally configured to detect code that appears in multiple programs, such as code 106a-c appearing in programs 104, 112, and 120 and replace the repeated code 106a-c with a corresponding API call 142. The API call 142 calls an API 132 that implements functions of code 106a-c. The code 106a-c may be optimized and/or scanned to improve functionality, and these changes are automatically propagated to each program 104, 112, 120.

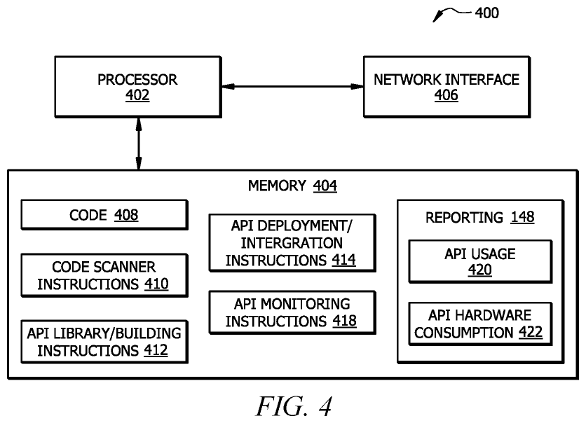

Each of the code repositories 102, 110 is generally a data store, or database, configured to store programs 104, 112. Each of the code repositories 102, 110 may be implemented using the processor, memory, and interface of device 400 described with respect to FIG. 4 below. Each program 104, 112 generally includes a series of instructions for executing one or more computing functions. For example programs 104, 112 may be application programs, such as internet browser programs, word processor programs, gaming programs, database system programs, spreadsheet programs, and the like, and/or system-level programs, such as operating system programs, networking programs, programming language programs, and the like. Each program 104 includes one or more segments of code, such as code 106a, 108 for program 102 and code 114a, 106b, 116 for program 112, as illustrated in FIG. 1. The segments of code 106a,b, 108, 114a, 116 include instructions, presented in any appropriate programming language for performing at least a portion of the functions of the corresponding program 104, 112. In the example of FIG. 1, program 104 stored in repository 102 includes code 106a that matches code 106b of program 112 stored in repository 110. In general code 106a and 106b is considered to be matching if the code 106a and 106b include substantially the same instructions. For example, code 106a and code 106b may include the same sequence of commands or instructions. Code 106a and 106b may be presented in the same or in a different programming language. As described in greater detail below, the code consolidation device 124 may be configured to detect matching code presented in different languages and generate an API 132, 134 that is compatible with each of the programming languages.

The computing device 118 is generally any computing device, such as a personal computer, mobile device, or the like, configured to implement a program 120. The computing device 118 may include the processor, memory, and/or interface of the device 400 described below with respect to FIG. 4. The program 120 executed by the computing device 118 may be any type of program, similarly to as described above for programs 104,112. Program 120 includes segments of code 106c, 114b and 122. In the example of FIG. 1, segment of code 106c matches (e.g., includes at least a threshold amount of the same instructions as) code 106a and 106b of programs 104 and 112, described above with respect to the program repositories 102, 110. Code 114b matches (e.g., includes at least a threshold amount of the same instructions as) code 114a of program 112. The code consolidation device 124 generally detects matching code 106a-c and 114a,b and replaces this code 106a-c and 114a,b with corresponding API calls 142 and 144, as described in greater detail below. Code 122 does not match code of other programs 104, 112. Replacing code 106c and 114b with API calls 142 and 144, respectively, generally decreases the amount of memory required to store program 120 on device 118, resulting in improved performance of the computing device 118.

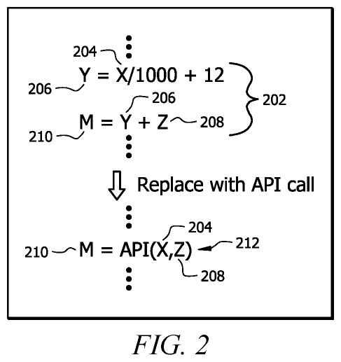

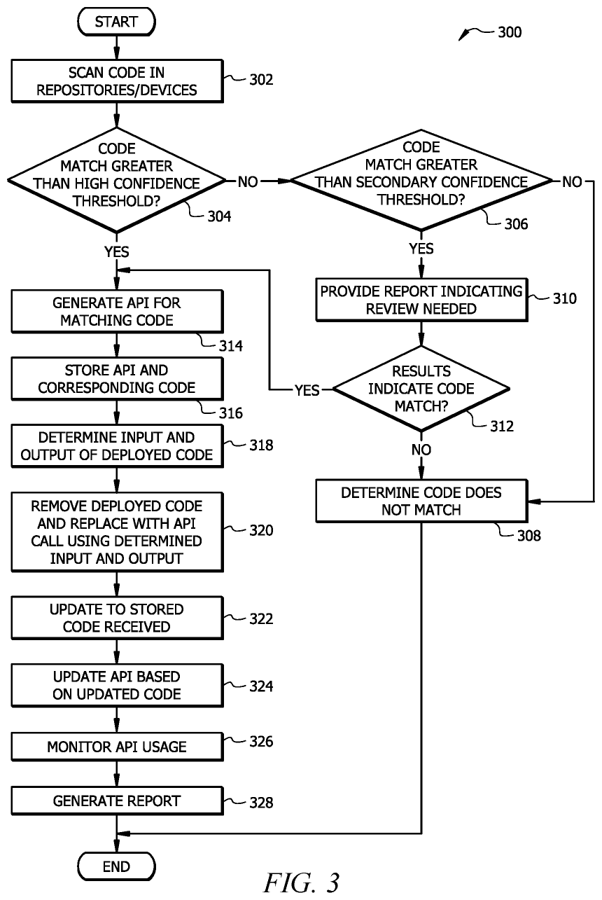

The code consolidation device 124 is generally any device or collection of devices (e.g., configured as a server or virtual server). The code consolidation device 124 may be implemented using the processor, memory, and interface of the device 400 described below with respect to FIG. 4. As described in greater detail with respect to the example implementation of system 100 and FIGS. 2 and 3, the code consolidation device 124 is generally configured to detect matching code 106a-c and 114a,b and replace the matching code 106a-c and 114a,b with a corresponding API calls 142 and 144. The code consolidation device 124 may include a code scanner 126, an API builder 128, an API initiator 140, and an API tester/monitor 146.

The code scanner 126 generally accesses and reviews the code 106a-c, 108, 114a,b, 116, 122 of programs 104, 112, and 120. The code scanner 126 may transform the code 106a-c, 108, 114a,b, 116, 122 to a standardized format used by the code consolidation device 124. For example, the code 106a-c, 108, 114a,b, 116, 122 may be converted to a standard programming language or a pseudo-programming language (e.g., which presents code 106a-c, 108, 114a,b, 116, 122, which may originally be in the same or a different language, to a format that facilitates comparison of the underlying function of the language). The code scanner 126 then determines whether code 106a-c, 108, 114a,b, 116, 122 from the different programs 104, 112, 120 matches or performs substantially the same functions. For example, the code scanner 126 may determine whether the code 106a-c, 108, 114a,b, 116, 122 of the different programs 104, 112, 120 (e.g., after being converted to a standardized format) matches at least a threshold amount (e.g., that at least 99% of the standardized code 106a-c, 108, 114a,b, 116, 122 of a given program 104, 112, 120 is the same as standardized code 106a-c, 108, 114a,b, 116, 122 of another program 104, 112, 120). For example, in some embodiments, the code 106a (e.g., after being converted a standardized format) must have a 100% match with the code 106b of program 114 in order to determine that the code 106a and 106b are a match.

The API builder 128 generally generates APIs 132 and 134 for the matching code 106a-c and 114a,b detected by the code scanner 126 and stores the APIs 132, 134 in the API database 130. The API builder 128 identifies the instructions indicated by each segment of matching code 106a-c and 114a,b and generates a corresponding API 132 and 134 that performs the same function(s). For example, if code 106a-c performs a series of calculations using one or more values as input(s) and generates one or more outputs, the corresponding API 132 is generated which receives the same inputs and performs the same calculation to generate the same output(s). Similarly, API 134 is generated which receives the input(s) of code 114a,b and generates the same output(s) as the code 114a,b (see also FIG. 2 and corresponding description below). The APIs 132, 134 are generally compatible with any programming language.

The API database 130 is generally any datastore configured to store the APIs 132, 134 generated by the code consolidation device 124. The API database 130 may be implemented using the processor, memory, and interface of the device 400 described with respect to FIG. 4 below. The APIs 132, 134 may be stored such that they are linked to a centralized copy of the matching code 106a-c, 114a,b as illustrated in FIG. 1. The centralized code 106a-c, 114a,b may be a preferred or optimized version of the instructions which are to be included in the APIs 132, 134. In some embodiments, the API database 130 is in communication with a programmer device 136, such that code changes 138 may be provided and integrated into the function of the APIs 132, 134. Once the changes 138 are implemented at the APIs 132, 134, the changes 138 are automatically propagated to the programs 104, 112, 120 calling APIs 132, 134. Thus, the matching segments of code 106a-c and 114a,b can be updated efficiently without having to track down each instance of the code 106a-c and 114a,b or make changes to the programs 104, 112, and 120. The programmer device 136 may be implemented using the processor, memory, and interface of the device 400 described with respect to FIG. 4 below.

Returning to the code consolidation device 124, the API initiator 140 automatically replaces the code 106a-c and 114a,b for which the APIs 132 and 134 were generated with corresponding API calls 142 and 144. Each API call 142, 144 is generally presented in the programming language employed by the program 104, 112, 120 to which the call 142, 144 is added. This generally allows the APIs 132, 134 to function seamlessly as though the associated code 106a-c and 114a,b were still included in the program. FIG. 2 illustrates an example of replacing matching code segments 106a-c or 114a,b with a corresponding API call 142, 144 to the API 132, 134. The segment of code 202 shown in FIG. 2 may correspond to segments of code 106a-c or 114a,b of FIG. 1. Code segment 202 includes an internal variable 206 (Y) that is defined in terms of a first input 204 (X). The output 210 (M) of code segment 202 is defined in terms the internal variable 206 and a second input 208 (Z). The API initiator 140 of FIG. 1 replaces the code segment 202 with an API call 212 corresponding to a call 142, 144 to API 132, 134 generated by the API builder 128. The API call 212 uses the first input 204 and second input 208 of the code segment 202 and generates the same output 210 of the code segment 202.

Returning to FIG. 1, the API tester/monitor 146 of the code consolidation device 124 is generally configured to test operation of and monitor usage of the APIs 132, 134 stored in the API database 130 (e.g., usage 140 of FIG. 4). For example, the API tester/monitor 146 may run APIs 132, 134 and determine an amount of processing resources or a processing time associated with the APIs 132, 134 in order to identify possible inefficiencies (e.g., API hardware consumption 422 of FIG. 4). As another example, the API tester/monitor 140 may monitor how frequently and/or by how many users the various APIs 132, 134 are used. For APIs 132, 134 used greater than a threshold amount, additional computing resources may be allocated to any devices executing programs 104, 112, 120 that call these APIs 132, 134. The API tester/monitor 140 may track an amount of secure data accessed by the APIs 132, 134. If access to greater than a threshold amount of secure data is detected (or if atypical access characteristics are otherwise detected), the API tester/monitor 140 may flag these APIs 132, 134 and/or identify particular users or devices accessing the secure data. The API tester/monitor 140 may provide increased visibility to the types of analysis being performed using the programs 104, 112, 120, and this information may be used to guide the development of new programs and/or updates of the APIs 132, 134 to provide improved functionality for these types of analyses.

The API tester/monitor 140 may generate reporting 148 which may be provided to the administrator device 150. The reporting 148 may identify any information determined or monitored by the API tester/monitor 140, such as, for example, usage of the APIs 132, 134, types of data accessed using the APIs 132, 134, type of analyses performed using the APIs 132, 134, irregular access of secure data using the APIs 132, 134, and the like. The administrator device 150 may be implemented using the processor, memory, and interface of the device 400 described with respect to FIG. 4 below.

Network 152 facilitates communication between and amongst the various components of system 100. This disclosure contemplates network 152 being any suitable network operable to facilitate communication between the components of system 100. Network 152 may include any interconnecting system capable of transmitting audio, video, signals, data, messages, or any combination of the preceding. Network 152 may include all or a portion of a public switched telephone network (PSTN), a public or private data network, a local area network (LAN), a metropolitan area network (MAN), a wide area network (WAN), a local, regional, or global communication or computer network, such as the Internet, a wireline or wireless network, an enterprise intranet, or any other suitable communication link, including combinations thereof, operable to facilitate communication between the components.

In an example operation of the system 100, the code consolidation device 124 uses the code scanner 126 to scan the programs 104, 112, 120 and detects matching segments of code 106a-c that perform a first set of programming tasks that are shared by programs 104, 112, and 120. The API builder 128 generates API 132 which is capable of performing the tasks or functions of the segments of code 106a-c. The API 132 may be stored in the API database 130 along with a copy of the code 106a-c. After the API 132 is generated, the API initiator 140 removes code 106a from program 104 and replaces the removed code 106a with API call 142. When added to program 104, API call 142 is in the programming language of program 104. The API initiator 140 similarly replaces code 106b and 106c with corresponding API calls 142 that are in the programming language of the respective programs 112 and 120. Any changes 138 to the API 132 are effectively automatically propagated to each of the programs 104, 112, 120 without requiring any modification to the programs 104, 112, 120. The API tester/monitor 146 monitors usage of the API 132 to determine if further computing resources should be allocated to the API 132, if secure information is being accessed irregularly, or the like, as described above.

### Example Methods of Operation

FIG. 3 illustrates a method 300 for operating the system 100 described above. The method 300 may begin at step 302 where the code consolidation device 124 scans the code 106a-c, 108, 114a,b, 116, 122 stored in the repositories 102, 110 and device 118. For example, the code consolidation device 124 may access the underlying code of programs 104, 112, 120 stored in devices (e.g., repositories 102, 110 and device 118 of FIG. 1) in communication with the code consolidation device 124.

At step 304, the code consolidation device 124 determines whether code 106a, 108 from one program 104 matches code 114a, 106b, 116 from program 112 and/or code 106c, 114b, 122 from program 120 within at least a first confidence or matching threshold. The first confidence threshold may correspond to a high matching threshold value at or above which automatic replacement of code 106a-c, 108, 114a,b, 116, 122 with an API call 142, 144 is appropriate. As described with respect to step 306-312 below, a second lower threshold value may be used to identify code 106a-c, 108, 114a,b, 116, 122 which may be replaced with an API call 142, 144 after administrator approval (see step 312). For example, as described above with respect to FIG. 1, the code consolidation device 124 may transform the code 106a-c, 108, 114a,b, 116, 122 to a standardized format, such as a preselected programming language or a pseudo-programming language. The code consolidation device 124 may determine the percentage of the code 106a-c, 108, 114a,b, 116, 122 (e.g., the text or instructions included in the code 106a-c, 108, 114a,b, 116, 122) from one program 104, 112, 120 that is the same as the code 106a-c, 108, 114a,b, 116, 122 of another program 104, 112, 120. In some embodiments, the code consolidation device 124 may employ a method of machine learning or artificial intelligence at step 304 to determine whether code 106a, 108 from one program 104 matches code 114a, 106b, 116 from program 112 and/or code 106c, 114b, 122 from program 120 within at least the first confidence or matching threshold. If the determined percentage is greater than the first threshold value (e.g., of 99% or more), then the code match is greater than the first confidence threshold at step 304. If the code match is greater than the first confidence threshold, the code consolidation device 124 proceeds to step 314. Otherwise, if the code match is not greater than the first confidence threshold, the code consolidation device 124 proceeds to step 306.

At step 306, the code consolidation device 124 determines whether code 106a, 108 from program 104 matches code 114a, 106b, 116 from program 112 and/or code 106c, 114b, 122 from program 120 within at least a second matching or confidence threshold. The second matching or confidence threshold is less than the first threshold used at step 304. For example, the second threshold may be an 80%, 90%, or 95% match of instructions or text in code 106a-c, 108, 114a,b, 116, 122 in different programs 104, 112, 120. In some embodiments, the code consolidation device 124 may employ a method of machine learning or artificial intelligence at step 306 to determine whether code 106a, 108 from one program 104 matches code 114a, 106b, 116 from program 112 and/or code 106c, 114b, 122 from program 120 within at least the second confidence or matching threshold. Generally, if code 106a-c, 108, 114a,b, 116, 122 matches (e.g., shares the same series of instructions) by less than the first threshold of step 304 but greater than the second threshold of step 306, administrator review and approval may be needed before code 106a-c, 108, 114a,b, 116, 122 is replaced with an API call 142, 144 (e.g., because there may be a subtle difference between the code 106a-c, 108, 114a,b, 116, 122 which cannot be reproduced using the same API 132, 134).

If the code 106a-c, 108, 114a,b, 116, 122 does not match by greater than the second confidence threshold at step 306, the code consolidation device 124 proceeds to step 308 and determines that there is no matching code 106a-c, 108, 114a,b, 116, 122, and method 300 ends. However, if the code 106a-c, 108, 114a,b, 116, 122 matches by greater than the second confidence threshold at step 306, the code consolidation device 124 proceeds to step 310 and generates a report (e.g., reporting 148 of FIG. 1) indicating review of the possibly matching code 106a-c, 108, 114a,b, 116, 122 is needed. If results are received at step 312 indicating that the code 106a-c, 108, 114a,b, 116, 122 matches, the code consolidation device 124 proceeds to step 314. The results may include an indication of whether the code matches to within some predefined similarity criteria. The criteria may be assessed by an administrator or other individual reviewing the code 106a-c, 108, 114a,b, 116, 122. Otherwise, the code consolidation device 124 proceeds to step 308 and determines that there is no matching code 106a-c, 108, 114a,b, 116, 122, and method 300 ends. In the example of FIG. 1, matching code 106a-c and 114a,b is identified at step 304 or 306.

At step 314, the code consolidation device 124 generates an API 132, 134 capable of performing the tasks and/or implementing actions of the matching code 106a-c, 114a,b identified at step 304 or 306. The generated API 132, 134 generally abstracts the functions of the code 106a-c, 114a,b which is to be replaced by an API call 142, 144 to the API 132, 134. For instance, in the example of FIG. 1, API 132 abstracts functions of the code 106a-c, and API 134 abstracts functions of code 114a,b. The API 132, 134 for code 106a-c, 114a,b may be generated by identifying the instructions indicated by each segment of matching code 106a-c and 114a,b and determining a corresponding API instructions that performs the same function(s). For example, if code 106a-c performs a series of calculations using one or more values as input(s) and generates one or more outputs, the corresponding API 132 is generated which receives the same inputs and performs the same calculation to generate the same outputs (see example code segment 202 and API call 212 of FIG. 2 described above). The generated API 132, 134 is stored at step 316.

In some embodiments, the code consolidation device 124 may use an API library (e.g., library 412 of FIG. 4) that stores API instructions (e.g., in any appropriate programming language) for each type of task or instruction that may be included in the programs 104, 112, 120 to aid in generating the API 132, 134. For instance, with respect to the example generation of API 132 for code 106a-c, the code consolidation device 124 may identify a first portion of the code 106a-c that corresponds to a first task (e.g., the determination of variable 206 (Y) shown in FIG. 2) and a second portion of the code 106a-c that corresponds to a second task (e.g., the determination of the output 210 (M) shown in FIG. 2). The code consolidation device 124 then determines a definition of each of these tasks (e.g., a task of “calculating Y” and a task of “calculating M”) and uses the API library to generate an API instruction that includes the sequential API instructions that correspond to the definitions of each of these tasks.

At step 318, the code consolidation device 124 may determine an input and output of the matching code identified at step 304 or 306. In some embodiments, step 318 is combined with step 314, such that input(s) and output(s) are determined as part of generating the API 132, 134. For instance, referring to the example of FIG. 2, the code consolidation device 124 may identify the inputs 204, 208 (X and Z) and output 210 (M) for the code segment 202. The determined input(s) and output(s) may be used to generate the API call 142, 144 with which the matching code 106a-c, 114a,b is replaced at step 320.

At step 320, the code consolidation device 124 causes each program containing the matching code 106a-c, 114a,b identified at step 304 or 306 to be modified. The code consolidation device 124 generally causes the automatic removal of the matching code 106a-c, 114a,b and replaces the removed code 106a-c, 114a,b with an API call 142, 144 to the API 132, 134 generated at step 314. The API call 142, 144 may use the input(s) and output(s) determined at step 318, as illustrated for API call 212 of FIG. 2. If automatic program modification is not possible (e.g., based on a security setting of a given device 118 or repository 102, 110), the code consolidation device 124 may provide instructions (e.g., as part of reporting 148) for the manual modification of the program 104, 112, 120 to include the API call 142, 144.

At step 322 an update or change 138 may be received to update the API 132, 134. The change 138 may indicate an update to the tasks to be performed by the API 132, 134 (or the corresponding code 106a-c, 114a,b associated with the API 132, 134). For instance, the code change 138 may indicate a different calculations to perform, a different data set to access for a calculation, and/or the like. At step 324, the API 132, 134 is updated based on the received change 138 (e.g., to implement the indicated change to the task(s) performed by the API 132, 134).

At step 326, the code consolidation device 124 may monitor usage of the API(s) 132, 134. The resulting usage data (e.g., usage data 420 of FIG. 4) may be associated with a frequency of use of the API 132, 134 (e.g., or of usage of API call 142, 144) and/or by how many devices/users the API 132, 134 is used. For an API 132, 134 used greater than a threshold amount, the code consolidation device 124 may automatically requisition additional computing resources to be allocated to any devices executing programs 104, 112, 120 that call the API 132, 134. The code consolidation device 124 may also or alternatively monitor an amount of secure data accessed by the API 132, 134. If access to greater than a threshold amount of secure data is detected (or if atypical access characteristics are otherwise detected), the code consolidation device 124 may flag the API 132, 134 and/or identify particular users or devices accessing the secure data. The code consolidation device 124 may monitor the types of analysis being performed using the programs 104, 112, 120 and/or data stores accessed during use of the programs 104, 112, 120. This information may be included in the reporting 148 generated at step 328 to guide the development of new programs and/or updates of the APIs 132, 134 to provide improved functionality for these types of analyses and/or for integrating with these data sources.

At step 328, the code consolidation device 124 generates reporting 148 that may identify any information determined or monitored at step 326, such as, for example, usage of the APIs 132, 134, type of data accessed using the APIs 132, 134, type of analyses performed using the APIs 132, 134, and the like.

### Example Device

FIG. 4 illustrates an embodiment of a device 400 configured to implement various components of the system 100. One or more devices 400 may be used to implement the program repositories 102, 110, computing device 118, code consolidation device 124, API database 130, programmer device 136, and/or administrator device 150 of FIG. 1. The device 400 includes a processor 402, a memory 404, and a network interface 406. The device 400 may be configured as shown or in any other suitable configuration.

The processor 402 comprises one or more processors operably coupled to the memory 404. The processor 402 is any electronic circuitry including, but not limited to, state machines, one or more central processing unit (CPU) chips, logic units, cores (e.g. a multi-core processor), field-programmable gate array (FPGAs), application specific integrated circuits (ASICs), or digital signal processors (DSPs). The processor 402 may be a programmable logic device, a microcontroller, a microprocessor, or any suitable combination of the preceding. The processor 402 is communicatively coupled to and in signal communication with the memory 404 and the network interface 406. The one or more processors are configured to process data and may be implemented in hardware or software. For example, the processor 402 may be 8-bit, 16-bit, 32-bit, 64-bit or of any other suitable architecture. The processor 402 may include an arithmetic logic unit (ALU) for performing arithmetic and logic operations, processor registers that supply operands to the ALU and store the results of ALU operations, and a control unit that fetches instructions from memory and executes them by directing the coordinated operations of the ALU, registers and other components. The one or more processors are configured to implement various instructions. For example, the one or more processors are configured to execute instructions to implement the function disclosed herein, such as some or all of those described with respect to the method 300 of FIG. 3. In some embodiments, the function described herein is implemented using logic units, FPGAs, ASICs, DSPs, or any other suitable hardware or electronic circuitry.

The memory 404 is operable to store any of the information described above with respect to FIGS. 1-3 along with any other data, instructions, logic, rules, or code operable to execute the function described herein. For example, the memory 404 may store code 408 (e.g., any of code 106a-c of FIG. 1), code scanner instructions 410 (e.g., instructions for implementing functions of the code scanner 126 of FIG. 1), an API library/API building instructions 412 (e.g., instructions for implementing functions of the API builder 128 of FIG. 1), API deployment/integration instructions 414 (e.g., instructions for implementing functions of the API initiator 140 of FIG. 1), API monitoring instructions 418 (e.g., instructions for implementing functions of the API tester/monitor 146 of FIG. 1), and reporting 148. The reporting 148 may include an indication of API usage 420 (e.g., a frequency execution or number of users executing the APIs 132, 134) and API hardware consumption 422 (e.g., a record of the processing, memory, and networking resources consumed to execute each API 132, 134). The memory 404 may be volatile or non-volatile and may comprise read-only memory (ROM), random-access memory (RAM), ternary content-addressable memory (TCAM), dynamic random-access memory (DRAM), and static random-access memory (SRAM).

The network interface 406 is configured to enable wired and/or wireless communications. The network interface 406 is configured to communicate data between the device 400 and other network devices, systems, or domain(s). For example, the network interface 406 may comprise a WIFI interface, a local area network (LAN) interface, a wide area network (WAN) interface, a modem, a switch, or a router. The processor 402 is configured to send and receive data using the network interface 406. The network interface 406 may be configured to use any suitable type of communication protocol as would be appreciated by one of ordinary skill in the art.

In addition, techniques, systems, subsystems, and methods described and illustrated in the various embodiments as discrete or separate may be combined or integrated with other systems, modules, techniques, or methods without departing from the scope of this disclosure. Other items shown or discussed as coupled or directly coupled or communicating with each other may be indirectly coupled or communicating through some interface, device, or intermediate component whether electrically, mechanically, or otherwise. Other examples of changes, substitutions, and alterations are ascertainable by one skilled in the art and could be made without departing from the spirit and scope disclosed herein.

To aid the Patent Office, and any readers of any patent issued on this application in interpreting the claims appended hereto, applicants note that they do not intend any of the appended claims to invoke 35 U.S.C. § 112(f) as it exists on the date of filing hereof unless the words “means for” or “step for” are explicitly used in the particular claim.

What is claimed is:

1. A system comprising:
a first repository configured to store a first set of computer programs;
a second repository configured to store a second set of computer programs; and
a code consolidation device communicatively coupled to the first repository and the second repository, the code consolidation device comprising a processor configured to:
identify a first segment of code included in a first computer program stored on the first repository that matches, within a threshold range, a second segment of code included in a second computer program stored on the second repository, wherein the first segment of code and the second segment of code are configured to perform one or more computing tasks;
generate an application programming interface (API) operable to perform the one or more computing tasks of the first and second segments of code;
store the generated API;
cause the first segment of code within the first computer program stored on the first repository to be replaced with a first call to the generated API; and
cause the second segment of code within the second computer program stored on the second repository to be replaced with a second call to the generated API.

2. The system of claim 1, wherein the processor is further configured to:
store the first segment of code with the generated API;
receive an update modifying the one or more tasks performed by the first segment of code;
after receiving the update to the first segment of code, generate an updated API operable to perform the modified one or more computing tasks of the updated first segment of code; and
replace the stored API with the updated API.

3. The system of claim 1, wherein:
the code consolidation device further comprises a memory configured to store an API library comprising, for each of a plurality of possible code portions, a corresponding task definition and API instruction; and
the processor is further configured to generate the API by:
identifying, using the API library, a first portion of the first segment of code corresponding to a first task;
identifying, using the API library, a second portion of the first segment of code corresponding to a second task; and
generating, using the API library, the API as a combination of a first API instruction corresponding to the first task and a second API instruction corresponding to the second task.

4. The system of claim 1, wherein the processor is further configured to
determine that the first segment of code matches the second segment of code by less than a first threshold amount associated with allowing automatic API generation but greater than a second threshold amount associated with a probable overlap of tasks performed by the first segment of code and the second segment of code;
in response to determining that the first segment of code matches the second segment of code by less than the first threshold amount but greater than the second threshold amount:
flag the first and second segments of code for review; and
receive an indication that the first segment of code matches the second segment of code within the threshold range.

5. The system of claim 1, wherein the processor is further configured to cause the first segment of code within the first computer program stored on the first repository to be replaced with the first call to the generated API by:
determining an input and an output associated with the first segment of code;
removing the first segment of code from the first program; and
appending the first call to the generated API in place of the removed first segment of code, wherein the first call to the generated API uses the determined input of the first segment of code as an API input and identifies an API output returned from the first call to the generated API as the determined output of the first segment of code.

6. The system of claim 1, wherein the processor is further configured to, after storing the generated API:
scan a personal computing device storing computer programs;
identify a third segment of code within a third computer program stored on the personal computing device that matches, within the threshold range, the first segment of code; and
cause the third segment of code within the third computer program stored on the first repository to be replaced with a third call to the generated API.

7. The system of claim 1, wherein the processor is further configured to:
monitor usage data associated with a frequency of use of the first call to the generated API and the second call to the generated API; and
generate a report comprising the usage data.

8. The system of claim 7, wherein the processor is further configured to:
determine, based on the usage data, that the generated API is used greater than a threshold amount; and
in response, generate the report indicating a high usage of the generated API.

9. A method, the method comprising, by a processor of a computing device:
identifying a first segment of code included in a first computer program stored on a first repository that matches, within a threshold range, a second segment of code included in a second computer program stored on a second repository, wherein the first segment of code and the second segment of code are configured to perform one or more computing tasks;
generating an application programming interface (API) operable to perform the one or more computing tasks of the first and second segments of code;
storing the generated API;
causing the first segment of code within the first computer program stored on the first repository to be replaced with a first call to the generated API; and
causing the second segment of code within the second computer program stored on the second repository to be replaced with a second call to the generated API.

10. The method of claim 9, further comprising, by the processor:
storing the first segment of code with the generated API;
receiving an update modifying the one or more tasks performed by the first segment of code;
after receiving the update to the first segment of code, generating an updated API operable to perform the modified one or more computing tasks of the updated first segment of code; and
replacing the stored API with the updated API.

11. The method of claim 9, wherein generating the API comprises:
identifying, using an API library, a first portion of the first segment of code corresponding to a first task, wherein the ASPI library comprises for each of a plurality of possible code portions, a corresponding task definition and API instruction;
identifying, using the API library, a second portion of the first segment of code corresponding to a second task; and
generating, using the API library, the API as a combination of a first API instruction corresponding to the first task and a second API instruction corresponding to the second task.

12. The method of claim 9, further comprising, by the processor:
determining that the first segment of code matches the second segment of code by less than a first threshold amount associated with allowing automatic API generation but greater than a second threshold amount associated with a probable overlap of tasks performed by the first segment of code and the second segment of code;
in response to determining that the first segment of code matches the second segment of code by less than the first threshold amount but greater than the second threshold amount:
flagging the first and second segments of code for review; and
receiving an indication that the first segment of code matches the second segment of code within the threshold range.

13. The method of claim 9, wherein causing the first segment of code within the first computer program stored on the first repository to be replaced with the first call to the generated API comprises:
determining an input and an output associated with the first segment of code;
removing the first segment of code from the first program; and
appending the first call to the generated API in place of the removed first segment of code, wherein the first call to the generated API uses the determined input of the first segment of code as an API input and identifies an API output returned from the first call to the generated API as the determined output of the first segment of code.

14. The method of claim 9, further comprising, after storing the generated API, by the processor:
scanning a personal computing device storing computer programs;
identifying a third segment of code within a third computer program stored on the personal computing device that matches, within the threshold range, the first segment of code; and
causing the third segment of code within the third computer program stored on the first repository to be replaced with a third call to the generated API.

15. The method of claim 9, further comprising, by the processor:
monitoring usage data associated with a frequency of use of the first call to the generated API and the second call to the generated API; and
generating a report comprising the usage data.

16. A device comprising:
a network interface configured to communicate with:
a first repository configured to store a first set of computer programs; and
a second repository configured to store a second set of computer programs; and
a processor communicatively coupled with the network interface and configured to:
identify a first segment of code included in a first computer program stored on the first repository that matches, within a threshold range, a second segment of code included in a second computer program stored on the second repository, wherein the first segment of code and the second segment of code are configured to perform one or more computing tasks;
generate an application programming interface (API) operable to perform the one or more computing tasks of the first and second segments of code;
store the generated API;
cause the first segment of code within the first computer program stored on the first repository to be replaced with a first call to the generated API; and
cause the second segment of code within the second computer program stored on the second repository to be replaced with a second call to the generated API.

17. The device of claim 16, wherein the processor is further configured to:
store the first segment of code with the generated API;
receive an update modifying the one or more tasks performed by the first segment of code;
after receiving the update to the first segment of code, generate an updated API operable to perform the modified one or more computing tasks of the updated first segment of code; and
replace the stored API with the updated API.

18. The device of claim 16, wherein:
the device further comprises a memory configured to store an API library comprising, for each of a plurality of possible code portions, a corresponding task definition and API instruction; and
the processor is further configured to generate the API by:
identifying, using the API library, a first portion of the first segment of code corresponding to a first task;
identifying, using the API library, a second portion of the first segment of code corresponding to a second task; and
generating, using the API library, the API as a combination of a first API instruction corresponding to the first task and a second API instruction corresponding to the second task.

19. The device of claim 16, wherein the processor is further configured to
determine that the first segment of code matches the second segment of code by less than a first threshold amount associated with allowing automatic API generation but greater than a second threshold amount associated with a probable overlap of tasks performed by the first segment of code and the second segment of code;
in response to determining that the first segment of code matches the second segment of code by less than the first threshold amount but greater than the second threshold amount:
flag the first and second segments of code for review; and
receive an indication that the first segment of code matches the second segment of code within the threshold range.

20. The device of claim 16, wherein the processor is further configured to cause the first segment of code within the first computer program stored on the first repository to be replaced with the first call to the generated API by:
determining an input and an output associated with the first segment of code;
removing the first segment of code from the first program; and
appending the first call to the generated API in place of the removed first segment of code, wherein the first call to the generated API uses the determined input of the first segment of code as an API input and identifies an API output returned from the first call to the generated API as the determined output of the first segment of code.
